(19) United States
(12) Patent Application Publication
(10) Pub. No.: US 2004/0221895 A1
(43) Pub. Date: Nov. 11, 2004

(54) Manual hand-held air deflating device

(76) Inventor: Margaret A. Fuller, Grasonville, MD (US)

Correspondence Address: MARGARET A. FULLER, 211 PROSPECT BAY DRIVE WEST, GRASONVILLE, MD, 21638, US

(21) Appl. No.: 10/430,873

(22) Filed: May 7, 2003

(51) Int. Cl. F16K 15/00

(52) U.S. Cl. 137/522

(57) ABSTRACT

A manual hand-held air deflating device for performing the release or injection of air from air-inflatables having an air valve with a recessed check valve. This device may be used for air-inflatables such as beach toys, rafts, floats and the like. The inventive device includes a handle having a top and bottom, a dowel having a first end and a second end attached to the handle, and a sleeve having a first end and second end that are identical. The top of the handle is only slightly curved to facilitate gripping function while the sides are curved for easier grip and holding. The bottom of the handle has a hole for placement of the dowel. The dowel is approximately 4 inches in length. From the bottom of the dowel to the middle of the dowel there is red coloring to mark the midway point of the dowel. The sleeve has two ends which are identical with no distinction between the two. The sleeve slides over the dowel.

### BACKGROUND OF THE INVENTION

1. Field of the Invention

The present invention relates to a device to deflate or inflate air inflatable objects. More specifically it relates to a manual hand-held air deflating/inflating device for performing the release or injection of air from air inflatable objects such as beach toys, rafts, floats, and other inflatables having as air valve with a recessed check valve.

2. Description of the Prior Art

It can be appreciated that air deflator/inflator devices have been in use for years. Typically, air deflator/inflator devices are comprised of prior art to inflate and or deflate objects by various methods. A person desiring to use such a device must decide what the object of intent is and how much air pressure is required. There are numerous objects containing air pressure and it is imperative that a choice be made as to what is being deflated or inflated.

The main problem with conventional air deflator/inflator devices are that some prior art requires connecting the adaptor to an additional air source, such as a vacuum cleaner, an air compressor, bicycle pumps or the like which provide a source or suction of air. Another problem with conventional air deflator/inflator devices are their nature is more complex. It is cumbersome to have inflatable objects, such as beach toys, rafts, floats and other items always inflated, but difficult to release the air from them with an air valve that has a recessed check valve. Prior art allows for more complex deflation or inflation of these objects by needing additional equipment or attachments not easily transported for a day at the beach, poolside or other outings. In reference to the present invention this device can be carried about easily, utilized simply, and requires no attachments or adaptations unlike prior art.

In these respects, the manual hand-held air deflating/inflating device according to the present invention substantially departs from the conventional concepts and designs of the prior art, and in so doing provides an apparatus primarily developed for the purpose of performing the release or injection of air from items having a recessed check valve.

### SUMMARY OF THE INVENTION

In view of the foregoing disadvantages inherent in the known types of air deflator/inflator devices now present in the prior art, the present invention provides a new manual hand-held air deflating/inflating device construction wherein the same can be utilized for performing the release or injection of air from items having an air valve with a recessed check valve.

The general purpose of the present invention, which will be described subsequently in greater detail, is to provide a new manual hand-held air deflating/inflating device that has many of the advantages of the air deflator/inflator devices mentioned heretofore and many novel features that result in a new manual hand-held air deflating/inflating device which is not anticipated, rendered obvious, suggested, or even implied by any of the prior art air deflator/inflator, either alone or in any combination thereof.

To attain this, the present invention generally comprises a handle having a top and bottom, a dowel having a first end and a second end attached to the handle, and a sleeve that is hollow and having a first end and second end that are identical. The handle has a top and bottom. The top is only slightly curved to facilitate gripping function, while the sides are curved for easier grip and holding. The bottom of the handle has a hole for placement of the dowel. The dowel is approximately 4 inches in length. From the bottom of the dowel to the middle of the dowel there is red coloring to mark the midway point of the dowel. The sleeve has two ends which are identical and with no distinction between the two. The sleeve being hollow easily slides over the dowel.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a manual hand-held air deflating/inflating device that will overcome the shortcomings of the prior art devices.

An object of the present invention is to provide a manual hand-held air deflating/inflating device for performing the release or injection of air from items having an air valve with a recessed check valve.

Another object is to provide a manual hand-held air deflating/inflating device that is easy to carry anywhere you go and requiring no other devices or adaptations for a source of air release.

Another object is to provide a manual hand-held air deflating/inflating device that can also be used to inflate an item by using one's own breath and blowing into the sleeve once inserted into the air valve with a recessed check valve.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, not necessarily to scale, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of the present invention.

FIG. 2 is a front view of the handle.

FIG. 3 is a bottom view of the handle.

FIG. 4 is a front view of the dowel.

FIG. 5 is a front view of the sleeve.

### DESCRIPTION OF THE PREFERRED EMBODIMENT

Turning now descriptively to the drawings, in which similar reference characters denote similar elements throughout the several views, the attached figures illustrate a manual hand-held air deflating/inflating device, which comprises a handle having a top and bottom, a dowel having a first end and a second end attached to the handle, and a sleeve having a first end and second end that are identical. The handle has a top and bottom. The top is only slightly curved to facilitate gripping function, while the sides are curved for easier grip and holding. The bottom of the handle has a hole for placement of the dowel. The dowel is approximately 4 inches in length. From the bottom of the dowel to the middle of the dowel there is red coloring to mark the midway point of the dowel. The sleeve has two ends which are identical and with no distinction between the two. The sleeve fits over the dowel.

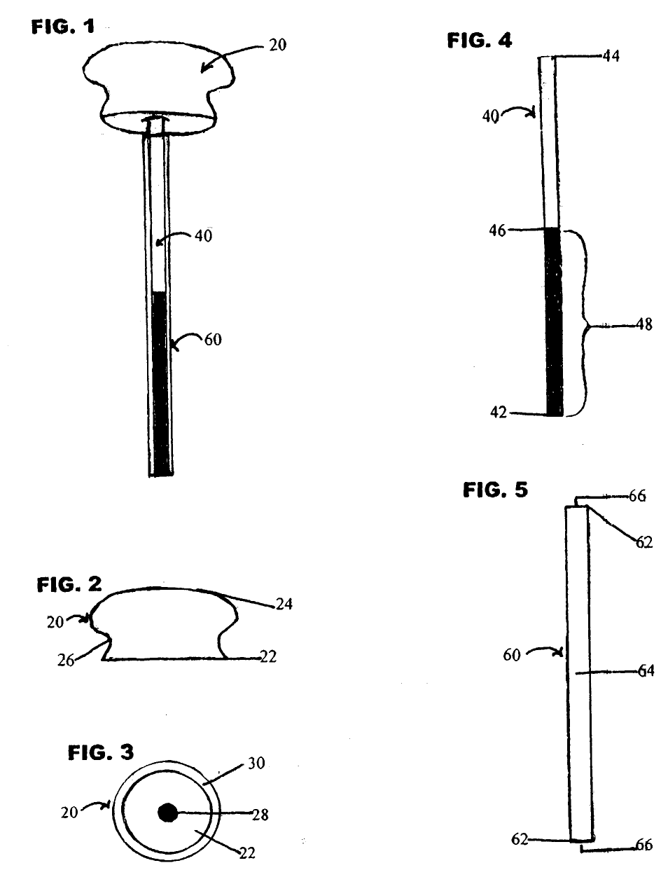

In the descriptions that follow all parts are marked and identified, but not necessarily to scale. As shown in FIGS. 1 through 3 of the drawings, the handle 20 has a top 24 and bottom 22 and has a curved portion in the middle 26. The top 24 is only slightly curved to facilitate gripping function. The underside 30 of the handle 20 has no distinguishing features. The curved portion in the middle 26 of the handle 20 allows for easier grip and holding. The bottom 22 of the handle 20 is flat and has a hole 28 in the center. The handle 20 may be constructed of wood, metal, fiberglass, or any other well-known material. As shown in FIG. 1, the bottom 22 of the handle 20 at the site of the hole 28 allows for the attachment of the dowel 40. The handle 20 is smooth to the touch to allow comfortable handling. The handle 20 may also be constructed from various other shapes and suitable materials that would be easy to grip and hold in one's hand. The hole 28 in the bottom 22 of the handle 20 may be a size to facilitate the dowel 40.

As shown in FIGS. 1 and 4 of the drawings, the dowel 40 has a top 44 and bottom 42. The dowel 40 is approximately 4 inches in length and has approximately a ½ inch circumference. The dowel 40 may be constructed of wood, metal, fiberglass, or any other well-known material. From the bottom 42 of the dowel 40 to the midway point 46 of the dowel 40 there is a red coloring 48 to mark the midway point 46 of the device. The bottom 22 of the handle 20 at the site of the hole 28 allows for the attachment of the dowel 40 by inserting the dowel 40 into the hole 28 and securing with glue. The dowel 40 may be constructed shorter, longer, or with a smaller or larger circumference as long as the larger circumference does not exceed the size of one way air valves that it is to be used for. The hole 28 in the bottom 22 of the handle 20 would have to be adjusted to facilitate any change in the size of the dowel 40. It is not mandatory to have the red coloring 48 on the dowel 40. This coloring could be various shades or be non-existant. If inserting the dowel 40 into the hole 28 on the bottom 22 of the handle 20 and securing with glue is insufficient, other methods of securing may be utilized.

As shown in FIGS. 1 and 5 of the drawings the sleeve 60 has two ends 62 which are identical and with no distinction between the two. The sleeve 60 must be slightly larger than the dowel 40 to allow it to fit over the dowel 40. The length of the sleeve 60 is only slightly shorter than the dowel 40. The sleeve has an open outlet 66 at each end 62 and a passageway 64 with a relatively consistent wall thickness, thus allowing the sleeve 60 to fit over the dowel 40. The sleeve 60 is constructed of a clear plastic to allow the view of the red coloring 48 on the dowel 40. The sleeve 60 may be constructed of any well-known material that allows the passageway 64 to be hollow and fit over the dowel 40. If the sleeve 60 is not clear there would be no need for the red coloring 48 or any coloring on the dowel 40.

The handle 20 accepts placement of the dowel 40 into the hole 28 on the bottom 22 of the handle 20. Completed in this manner, the handle 20 with the dowel 40 in place provides the main body of the device. The clear sleeve 60, by using either end 62, is placed over the dowel 40 through the open outlet 66 and the device is ready to be used on an inflatable object. The handle 20 and dowel 40 are made from wood. The sleeve 60 is a clear, hollow tube with a relatively consistent wall thickness. The handle 20 can be made in various sizes, shapes and suitable materials. However, the size of the hole 28 on the bottom 22 must be a size to facilitate the dowel 40. The dowel 40 can be of various lengths and thickness and made of suitable materials, but circumference must not exceed the opening size of the air valve with a recessed check valve. The sleeve 60 can be made of suitable materials, but must be only slightly larger than the dowel 40, and no larger than the opening size of the one way air valve of the object to be deflated or inflated. The length of the dowel 40 and the sleeve 60 may be shortened or lengthened, but not too long to pierce the inflatable object. The red coloring 48, or any coloring, need not be on the dowel 40 if the sleeve 60 is not clear. However, if the sleeve 60 is not clear and the red coloring 48 on the dowel 40 or any coloring is not present, then one end 62 of the sleeve might be altered to keep the sleeve 60 from slipping into the inflatable object.

In reference to the foregoing discussion, the objective of the operation of the present invention is to provide a manual deflation device, which may also be used for inflation of air-inflatable objects having an air valve with a recessed check valve. Some of the air-inflatable objects may be beach toys, such as rafts, beach balls, swim rings and other toys. It is important to recognize that this invention is not a toy, but to be used on some toys. This device can be produced inexpensively, is convenient to have on hand and operate, portable and lightweight.

To construct the device, obtain a handle 20, a dowel 40, and a sleeve 60, as seen in FIG. 1. The handle 20 and dowel 40 are constructed from wood. The sleeve 60 is constructed from clear plastic. Other suitable materials may be used in constructing the device. The bottom 22 of the handle 20 at the site of the hole 28 allows for the attachment of the dowel 40 by inserting the dowel 40 into the hole 28 and securing with glue. The dowel 40 is then measured for a midway point 46 and painted with red coloring 48 from the bottom 22 to the midway point 46. The sleeve 60 easily slides onto the dowel 40. The device is ready for use.

To operate the device to deflate objects, pick up the handle 20 and hold the handle 20 in your right or left hand. Place a sleeve 60 over the dowel 40 and push the sleeve 60 to the top 44 of the dowel 40. While holding the sleeve 60 on the dowel 40 with finger pressure place the ends 42,62 of the device into the air valve of the object to be deflated. Be sure the ends 42,62 are pushed past the recessed check valve within the air valve. Do not push the dowel 40 or sleeve 60 into the air valve past the red coloring 48 as the inflatable object might be pierced or the sleeve 60 might eventually slip inside the inflatable. Hold the sleeve 60 in position inside the air valve with one hand and remove the dowel 40 by pulling the handle 20 up and out of the inflatable. With the sleeve 60 in place, start to press on your inflatable to force the air out. Begin to roll, fold or squeeze the inflatable to force the air out and the air will escape through the sleeve 60. After the air has been removed, remove the sleeve 60 from the air valve.

To operate the device to inflate objects, pick up the handle 20 and hold the handle 20 in your right or left hand. Place a sleeve 60 over the dowel 40 and push the sleeve 60 to the top 44 of the dowel 40. While holding the sleeve 60 on the dowel 40 with finger pressure place the ends 42, 62 of the device into the air valve of the object to be inflated. Be sure the ends 42, 62 are pushed past the recessed check valve within the air valve. Do not push the dowel 40 or sleeve 60 into the air valve past the red coloring 48 as the inflatable object might be pierced or the sleeve 60 might eventually slip inside the inflatable. Hold the sleeve 60 in position inside the air valve with one hand and remove the dowel 40 by pulling the handle 20 up and out of the inflatable. With the sleeve 60 in place, start to blow into the sleeve 60 using lung power as your source to inflate the object. With the sleeve 60 in place, the recessed check valve stays open and it is easier to put air into the inflatable object. The sleeve 60 acts as an extension of the air valve. After the inflatable object has been blown up satisfactorily, remove the sleeve 60 from the air valve and close the cap on the air valve to prevent escape of air.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A simple manual hand-held air deflating device for use with inflatable objects with an air valve with a recessed check valve comprising:
a handle to accommodate the holding of the device
a dowel to provide stability to the sleeve
a sleeve to be inserted into the air valve acting as an extension of the air valve

2. The handle as in claim 1 is shaped with a top and bottom being curved across the top to facilitate gripping function

3. The dowel as in claim 1 is a solid piece, and only defined by a demarcation line for the midway point:
a red coloring marks the midway point of the dowel

4. The sleeve as in claim 1 has two identical ends:
both ends are identical with no distinction between the two
